(19) United States
(12) Patent Application Publication
(10) Pub. No.: US 2012/0066696 A1
(43) Pub. Date: Mar. 15, 2012

(54) GENERIC HARDWARE AND SOFTWARE PLATFORM FOR ELECTRONIC DEVICES IN MULTIMEDIA, GRAPHICS, AND COMPUTING APPLICATIONS

(76) Inventors: Sattam Dasgupta, Bangalore (IN); Ritesh Ramesh Parekh, Bangalore (IN); Aadithya Vishwanath Kamath, Bangalore (IN); Anil Kumar Agara Venkatesha Rao, Bangalore (IN)

(21) Appl. No.: 13/227,500

(22) Filed: Sep. 8, 2011

(30) Foreign Application Priority Data
Sep. 9, 2010 (IN) 2647/CHE/2010

(51) Int. Cl. G06F 9/54; G06F 13/14

(52) U.S. Cl. 719/328; 710/305

(57) ABSTRACT

A generic hardware and software platform for electronic devices in multimedia, graphics, and computing applications are disclosed. In one embodiment, the generic hardware platform includes one of a single bus link or multiple bus link. Further, the generic hardware platform includes one or more of a power module, a processor, a memory device, a security engine, an environmental device, a man machine interface (MMI) device and a medical device coupled to the one of the single bus link or multiple bus link via an associated interface. Furthermore, the generic hardware platform includes one or more of a storage device, a video/image input device, a video/image output device, an audio input device, an audio output device, a location, position, and motion device, a wireless communication channel, a wired communication channel, and a timer coupled to the one of the single bus link or multiple bus link via an associated interface.

Benefit is claimed under 35 U.S.C 119(a) to Indian Provisional Application Ser. No. 2647/CHE/2010 entitled “End usage agnostic hardware and software platform for electronic devices in multimedia/graphics/computing applications” by Ittiam Systems (P) Ltd filed on Sep. 9, 2010.

### FIELD OF TECHNOLOGY

Embodiments of the present invention relate to the field of electronic devices. More particularly, embodiments of the present invention relate to providing a generic hardware and software platform for electronic devices in multimedia, graphics, and computing applications.

### BACKGROUND

For an increasing number of applications, software and hardware technologies are converging. This means that multiple functionalities including computation (e.g., traditional personal computers (PCs) and the like), multimedia processing and streaming (e.g., a player, a recorder, a server, a client and the like), Internet enabled applications (e.g., mobile Internet devices (MIDs), tablets and the like), communication over Internet protocol (IP) and gaming are converging on a single equipment or device. Further, input, output and connectivity technologies are also converging to provide different forms of wireless and wired connections on the single equipment or device with different types of transducers (e.g., a camera, a display, a microphone, a speaker, an accelerometer and the like).

Currently, silicon platforms are capable of supporting the functionalities mentioned above. Further, common software frameworks/stacks are emerging that provide a basic infrastructure for application development covering the functionalities. Furthermore, high performance and low power requirements are converging on a single silicon platform. Today, the single silicon platform can deliver high performance computing, multimedia processing, and graphics at low power consumption levels. Moreover, cost of the single silicon platform delivering the high performance and low power is progressively reducing and is low enough to be in mass produced consumer devices. However, existing hardware and software architectures for various electronic devices do not take advantage of these overlapping functionalities, the silicon platforms and software advancements to provide a common hardware/software platform for electronic devices having different end usage scenarios or primary functions but overlapping functionalities.

### BRIEF DESCRIPTION OF THE DRAWINGS

Embodiments of the present invention are illustrated by way of an example and not limited to the figures of the accompanying drawings, in which like references indicate similar elements and in which:

FIG. 1 illustrates a personal computer (PC), a laptop and a net book having similar functions but different usage scenarios;

FIG. 2 illustrates various electronic devices other than the PC, having different functions and different usage scenarios;

FIG. 3 illustrates various electronic devices which are converging towards having significantly overlapping functionalities although having different primary purposes;

FIG. 4 is a table including various electronic devices having different end usage scenarios and different form factors but having significant common functionalities;

FIG. 5 is a table including the various electronic devices, such as those shown in FIG. 4, having a significant level of commonality in input, output and connectivity hardware options;

FIG. 6 is a block diagram illustrating a generic hardware platform architecture for electronic devices in multimedia, graphics, and computing applications, according to one embodiment;

FIG. 7 is a block diagram illustrating a generic software platform architecture for the electronic devices in multimedia, graphics, and computing applications, according to one embodiment; and

FIG. 8 is a block diagram illustrating major software modules in middleware in the generic software platform architecture, such as the one shown in FIG. 7, according to one embodiment.

Other features of the present embodiments will be apparent from the accompanying drawings and from the detailed description that follows.

### DETAILED DESCRIPTION

A generic hardware and software platform for electronic devices in multimedia, graphics, and computing applications are disclosed. In the following detailed description of the embodiments of the invention, references are made to the accompanying drawings that form a part hereof, and in which are shown, by way of illustration, specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined by the appended claims.

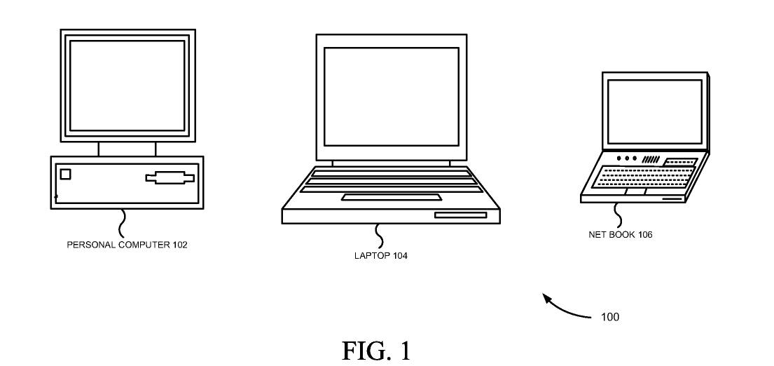

FIG. 1 illustrates various electronic devices, such as a personal computer (PC) 102, a laptop 104 and a net book 106 having similar functions but different usage scenarios. Further, the PC 102, the laptop 104 and the net book 106 serve same end purpose. However, the PC 102, the laptop 104 and the net book 106 use same hardware/software platform.

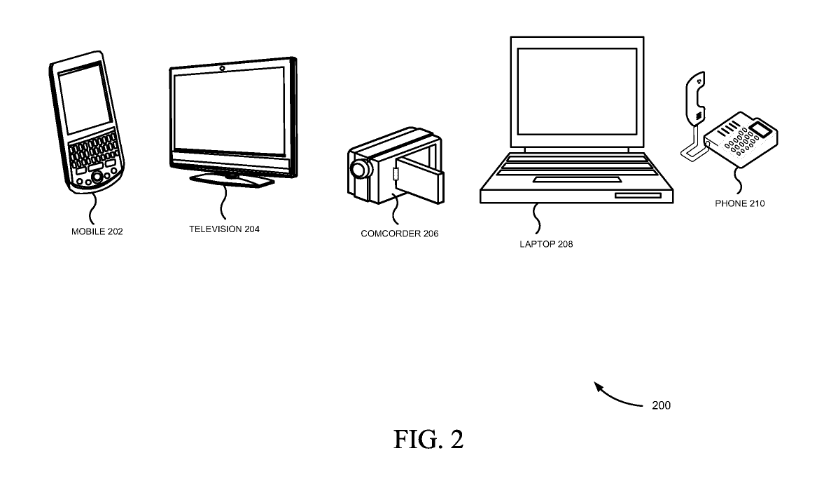

Referring now to FIG. 2, which illustrates various electronic devices, other than the PC 102, having different functions and different usage scenarios. Exemplary electronic devices include a mobile 202, a television (TV) 204, a camcorder 206, a laptop 208, a phone 210, and the like. Further, FIG. 2 shows the electronic devices with different functions which serve different purposes, different usage scenarios and use different hardware/software platform.

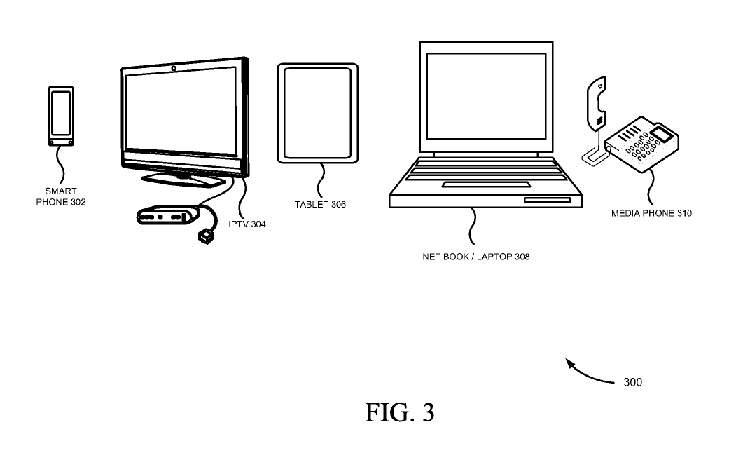

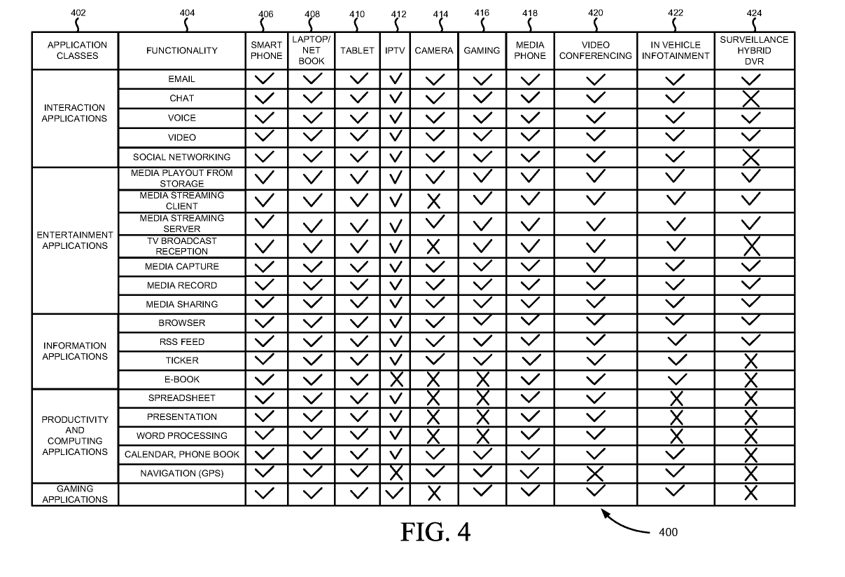

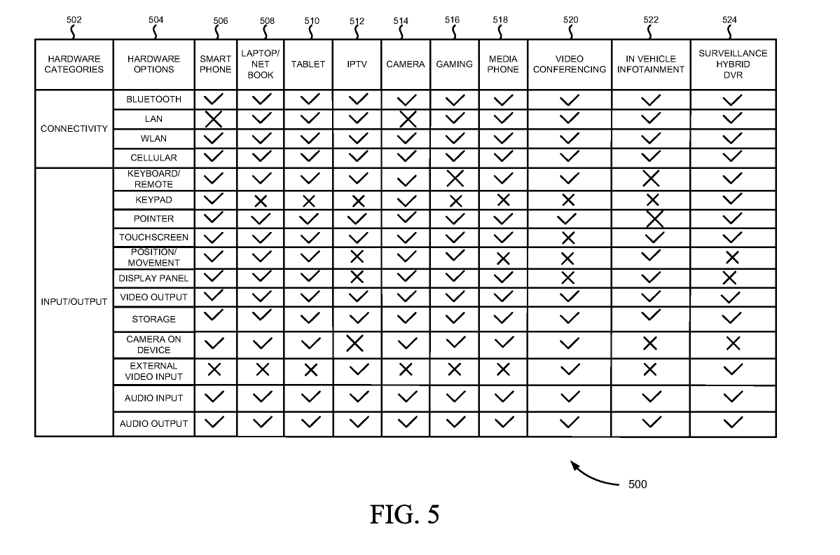

Referring now to FIG. 3, which illustrates various electronic devices which are converging towards having significantly overlapping functionalities although having different primary purposes. Exemplary electronic devices include a smart phone 302, an Internet protocol television (IPTV) 304, a tablet 306, a net book/laptop 308, a media phone 310 and the like. The overlapping functionalities of the various electronic devices are explained below in more detail with reference to FIGS. 4 and 5.

Referring now to FIG. 4, which illustrates a table 400 including various electronic devices having different end usage scenarios and different form factors but having significant common functionalities. In the table 400, ‘√’ indicates a functionality provided by an associated electronic device. Further in the table 400, ‘X’ indicates a functionality that is not provided by an associated electronic device.

Furthermore in the table 400, column 402 includes application classes, such as interaction applications, entertainment applications, information applications, productivity and computing applications and gaming applications. In addition in the table 400, column 404 includes various functionalities associated with each of the application classes. Also in the table 400, columns 406 to 424 include the functionality provided by the various electronic devices. For example, email functionality is a common functionality across the various electronic devices.

Referring now to FIG. 5, which illustrates a table 500 including the various electronic devices, such as those shown in FIG. 4, also having a significant level of commonality in input, output and connectivity hardware options. In the table 500, ‘√’ indicates a hardware option provided by an associated electronic device. Further in the table 400, ‘X’ indicates a hardware option that is not provided by an associated electronic device.

Furthermore in the table 500, column 502 includes hardware categories, such as connectivity and input/output. In addition in the table 500, column 504 includes hardware options associated with each of the hardware categories. Also in the table 500, columns 506 to 524 include the input, output and connectivity hardware options provided by the various electronic devices. For example, Bluetooth® (BT) is a common connectivity hardware option provided across the various electronic devices.

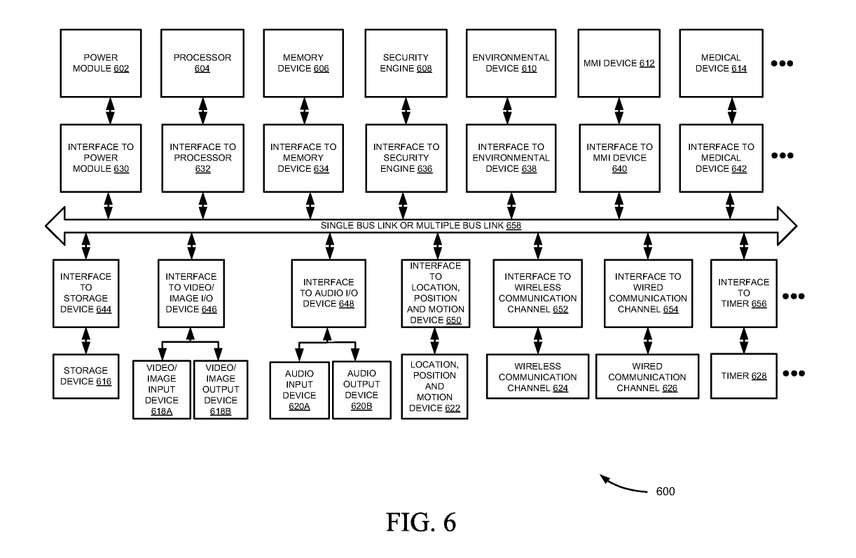

Referring now to FIG. 6, which illustrates a block diagram of a generic hardware platform architecture 600 for the electronic devices in multimedia, graphics, and computing applications, according to one embodiment. As shown in FIG. 6, the generic hardware platform architecture 600 includes one or more of a power module 602, a processor 604, a memory device 606, a security engine 608, an environmental device 610, a man machine interface (MMI) device 612, a medical device 614 and the like. Further as shown in FIG. 6, the generic hardware platform architecture 600 includes one or more of an interface to power module 630, an interface to processor 632, an interface to memory device 634, an interface to security engine 636, an interface to environmental device 638, an interface to MMI device 640, an interface to medical device 642 and the like coupled between an associated one of the power module 602, the processor 604, the memory device 606, the security engine 608, the environmental device 610, the MMI device 612, the medical device 614 and the like and one of a single bus link or a multiple bus link 658.

Furthermore as shown in FIG. 6, the generic hardware platform architecture 600 includes one or more of a storage device 616, a video/image input device 618A, a video/image output device 618B, an audio input device 620A, an audio output device 620B, a location, position, and motion device 622, a wireless communication channel 624, a wired communication channel 626, a timer 628 and the like. In addition as shown in FIG. 6, the generic hardware platform architecture 600 includes one or more of an interface to storage device 644, an interface to video/image input/output (I/O) device 646, an interface to audio I/O device 648, an interface to location, position, and motion device 650, an interface to wireless communication channel 652, an interface to wired communication channel 654, an interface to timer 656 and the like coupled between an associated one of the storage device 616, the video/image input device 618A, the video/image output device 618B, the audio input device 620A, the audio output device 620B, the location, position, and motion device 622, the wireless communication channel 624, the wired communication channel 626, the timer 628 and the like and the one of the single bus link or the multiple bus link 658. In some embodiments, the generic hardware platform architecture 600 includes other electronic devices, such as industry specific measurement devices, transducers, and other peripherals that are non-standard or emerging standards, such as Near Field Communication (NFC) and the like. Further, the generic hardware platform architecture 600 includes an interface to other electronic devices, such as an universal serial bus (USB) and the like coupled between the other electronic devices and the one of the single bus link or the multiple bus link 658.

In the embodiment illustrated in FIG. 6, the power module 602 includes at least one of an alternating current (AC) source, a direct current (DC) source, a power over Ethernet (PoE), a battery and the like. For example, the processor 604 includes at least one of a general purpose processor (GPP), a graphics processing unit (GPU), and a video processing unit (VPU). The memory device 606 includes at least one of a NAND memory, a NOR memory, a synchronous dynamic random access memory (SDRAM), a OneNAND memory, a static random access memory (SRAM) and the like. The security engine 608 includes a trusted platform module (TPM) defined by a Trusted Computing Group™ and the like. The environmental device 610 includes at least one of an ambient light sensor, a pressure sensor, a temperature sensor and the like. The MMI device 612 includes at least one of an infrared (IR) remote, a BT based USB mouse/keyboard, an IR based mouse/keyboard, a touch screen, a keypad, a gesture recognition device, a voice/speech recognition device and the like. The medical device 614 includes at least one of a personal health record, a glucometer, a blood pressure monitor and the like.

Further in the embodiment illustrated in FIG. 6, the storage device 616 includes at least one of an USB based flash drive, a hard disk, a multimedia card (MMC), an embedded multimedia card (eMMC™), a secure digital (SD) card, a memory stick, a memory pro and the like. The video/image input device 618A includes at least one of a camera sensor, an analog/digital camera and the like. The video/image output device 618B includes at least one of a liquid crystal display (LCD) panel, a standard-definition television (SD TV), a high-definition television (HD TV), a projector and the like. The audio input device 620A includes at least one of a microphone, an array microphone, a line in source and the like. The audio output device 620B includes at least one of a speaker, an amplifier and the like. The location, position and motion device 622 includes at least one of a gyroscope, a motion sensor, an accelerometer, a digital compass and the like. The wireless communication channel 624 includes at least one of a wireless local area network (WLAN), a worldwide interoperability for microwave access (WiMAX™), a 3^{rd} generation (3G) network and the like. The wired communication channel 626 includes at least one of a copper communication channel, a fiber communication channel, an USB and the like. The timer 628 includes at least one of a watchdog timer, a real time clock and the like.

Furthermore in the embodiment illustrated in FIG. 6, the interface to storage device 644 includes at least one of an USB, a peripheral component interconnect (PCI), a peripheral component interconnect express (PCIe) and the like. The interface to video/image I/O device 646 includes at least one of a BT.656, a BT.1120, a high-definition serial digital interface (HD-SDI), a high-definition multimedia interface (HDMI®), a low voltage differential signaling (LVDS), an USB, a separate video (S-video), a video graphic array (VGA) and the like. The interface to audio I/O device 648 includes at least one of an integrated interchip sound (I2S) interface, a pulse code modulator (PCM) interface, an audio codec' 97 (AC97) interface, a HDMI®, a HD-SDI, an USB, a PCI, a PCIe, a BT and the like. The interface to wireless communication channel 652 includes at least one of an USB, a secure digital input/output (SDIO), a compact flash (CF®), a universal asynchronous receiver transmitter (UART) and the like. The interface to wired communication channel 654 includes at least one of a media independent interface (MII), a gigabit media independent interface (GMII), a reduced gigabit media independent interface (RGMII), a serial gigabit media independent interface (SGMII), an USB and the like. The interface to location, position and motion device 650, the interface to MMI device 640, the interface to medical device 642, the interface to environmental device 638, and the interface to security engine 636 include at least one of an inter-integrated circuit (I2C), a serial peripheral interface (SPI™), an UART, an USB and the like. The interface to power module 630 includes at least one of an I2C, a SPI™ and the like. The interface to processor 632 includes at least one of an advanced microcontroller bus architecture (AMBA™) bus, a PCIe, an advanced graphics port (AGP) and the like. The interface to memory device 634 includes at least one of a NAND interface, an asynchronous interface, a Motorola™ interface, an Intel™ interface, a synchronous interface, a double data rate (DDR) interface and the like. The interface to timer 656 includes at least one of an I2C, a SPI™, a register based interface and the like.

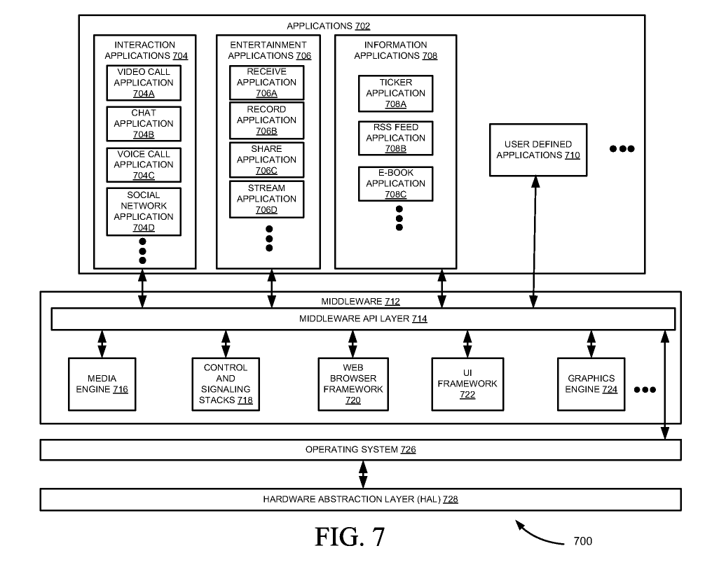

Referring now to FIG. 7, which illustrates a block diagram of a generic software platform architecture 700 for the electronic devices in multimedia, graphics, and computing applications, according to one embodiment. As shown in FIG. 7, the generic software platform architecture 700 includes a hardware abstraction layer (HAL) 728 (also referred to as a board support package (BSP)), an operating system 726, middleware 712 and a plurality of applications 702.

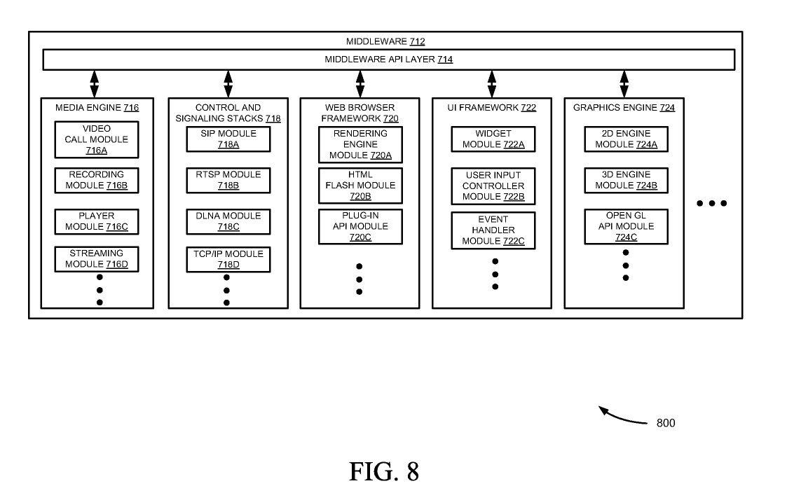

Further as shown in FIG. 7, the middleware 712 includes a middleware application programming interface (API) layer 714, a media engine 716, control and signaling stacks 718, a web browser framework 720, a user interface (UI) framework 722, a graphics engine 724 and the like. This is explained below in more detail with reference to FIG. 8.

Furthermore as shown in FIG. 7, the operating system 726 is coupled to the HAL 728. In addition, the middleware API layer 714 is coupled to the operating system 726. Also, the plurality of applications 702 is coupled to the middleware API layer 714. Moreover, the media engine 716, the control and signaling stacks 718, the web browser framework 720, the UI framework 722, and the graphics engine 724 are coupled to the middleware API layer 714.

In one embodiment, the HAL 728 provides lower layer driver software for various hardware devices, such as components, interfaces and peripherals and the like included in the generic hardware platform architecture 600, such as the one shown in FIG. 6. Further, the operating system 726 provides lower layer operating system functionalities, such as a device driver API, memory management, scheduling, and the like. Furthermore, the middleware 712 provides an application development platform via well defined APIs for multiple high complexity and compute intensive core functional blocks that are used across various applications. The plurality of the applications 702 includes several applications that cater to all use cases across the various targeted electronic devices using the middleware API layer 714 and provides a framework to create user defined applications 710 to extend the functionality of the generic software platform architecture. Exemplary user defined applications includes applications to interact or interoperate with the other electronic devices.

In this embodiment, the plurality of applications 702 includes one or more interaction applications 704, one or more entertainment applications 706, one or more information applications 708, the user defined applications 710 and the like. Further, the one or more interaction applications 704 includes at least one of a video call application 704A, a chat application 704B, a voice call application 704C, a social network application 704D and the like. The one or more entertainment applications 706 includes at least one of a receive application 706A, a record application 706B, a share application 706C, a stream application 706D and the like. The one or more information applications 708 includes at least one of a ticker application 708A, a really simple syndication (RSS) feed application 708B, an e-book application 708C and the like.

Referring now to FIG. 8, which illustrates a block diagram 800 illustrating major software modules in the middleware 712 in the generic software platform architecture 700, such as the one shown in FIG. 7, according to one embodiment. As explained above, the middleware 712 includes the middleware API layer 714 coupled to the media engine 716, the control and signaling stacks 718, the web browser framework 720, the UI framework 722, the graphics engine 724 and the like.

As shown in FIG. 8, the media engine 716 includes at least one of a video call module 716A, a recording module 716B, a player module 716C, a streaming module 716D and the like. Further, the control and signaling stacks 718 include at least one of a session initiation protocol (SIP) module 718A, a real time streaming protocol (RTSP) module 718B, a digital living network alliance (DLNA) module 718C, a transmission control protocol/Internet protocol (TCP/IP) module 718D and the like. Furthermore, the web browser framework 720 includes at least one of a rendering engine module 720A, a hypertext markup language (HTML) flash module 720B, a plug-in API module 720C and the like. In addition, the UI framework 722 includes at least one of a widget module 722A, a user input controller module 722B, an event handler module 722C and the like. Moreover, the graphics engine 724 includes at least one of a two dimension (2D) engine module 724A, a three dimension (3D) engine module 724B and an open graphics library (GL) API module 724C.

In one example, a hybrid digital video recorder (DVR) used in applications, such as a video surveillance and a healthcare is implemented in the generic hardware platform architecture 600 and the generic software platform architecture 700, such as those shown in FIGS. 6 and 7, respectively. The key functions performed by the hybrid DVR are multimedia recording, playback and streaming over multiple audio/video channels. Some of the crucial peripherals and components for the hybrid DVR are multiple audio and video inputs, audio and video outputs and wired connectivity options.

The embodiment illustrated in FIG. 6 includes all the components required for the hybrid DVR. For example, the processor 604 and the memory device 606 are essential for multimedia and graphics processing. Further, the video/image input device 618A and the audio input device 620A, such as the line in source are used to get multiple audio and video inputs into the hybrid DVR. Furthermore, the interface to video/image I/O device 646 and the interface to audio I/O device 648 are used for audio and video output. In addition, the wired communication channel 624, such as Ethernet is used for streaming and remote operations. Also, user inputs are given to the hybrid DVR via the MMI device 612, such as the IR remote. Moreover, the hybrid DVR uses the storage device 616, such as the SD card, the MMC and a serial advanced technology attachment (SATA).

The embodiments illustrated in FIGS. 7 and 8 include software required for the hybrid DVR. The hybrid DVR uses the HAL 728 and the operating system 726 in the generic software platform architecture 700, shown in FIG. 7. The media engine 716 performs the primary functions of the hybrid DVR, such as recording, playback and streaming. The control and signaling stacks 718 include a RTP module, the RTSP module 718B and hypertext transfer protocol (HTTP) functionalities required for the streaming and remote operation requirements. The applications, such as a play out application, the record application 706B, the stream application 706D and the like are used in the hybrid DVR. Additional applications, such as an e-mail application, the chat application 704B, the voice call application 704C and the like are used in advanced hybrid DVR.

In another example, a video conferencing set-top box (STB) for high quality video conferencing in conjunction with an existing standard or the HD TV is implemented in the generic hardware platform architecture 600 and the generic software platform architecture 700, such as those shown in FIGS. 6 and 7, respectively. The primary function performed by the video conferencing STB is voice and video calling. However, additional functions, such as chat, browser and the like are also required for higher end video conferencing STBs. Some of the crucial peripherals and components for the video conferencing STB are external audio and video inputs, audio and video outputs and wired connectivity options.

The embodiment illustrated in FIG. 6 includes the components required for the video conferencing STB. For example, the processor 604 and the memory device 606 are essential for multimedia and graphics processing. Further, audio and video inputs are via a HD TV interface and an array microphone interface, respectively. Furthermore, the HD TV interface is used for audio and video output to connect to a HD TV. In addition, the wired communication channel 626, such as Ethernet is used for streaming and administrative control operations. Also, user inputs are given to the hybrid DVR via the MMI device 612, such as the IR remote.

The embodiments illustrated in FIGS. 7 and 8 include software required for the video conferencing STB. Further, the video conferencing STB uses the HAL 728 and the operating system 726 in the generic software platform architecture 700. Similar to the hybrid DVR, the media engine 716 performs primary functions of a voice and video call including special functions like recording of a call. The control and signaling stacks 718 includes the RTP module for media exchange and the SIP module 718A for signaling. The applications, such as the voice call application 704C and the video call application 704A are used in the video conferencing STB. Additional applications, such as a chat application 704B, a browser application, the ticker application 708A and the like are used in advanced video conferencing STBs.

In yet another example, a mobile Internet device (MID) also known as Internet tablets targeted for personal use to consume online multimedia, data and interact with the world using several Internet enabled applications is implemented in the generic hardware platform architecture 600 and the generic software platform architecture 700, such as those shown in FIGS. 6 and 7, respectively. Further, the primary functions performed by the MID are web browsing and media playback. Furthermore, the additional functions, such as social networking, chat, media recording, media sharing and browser are required for higher end MIDs. In addition, the crucial peripherals and components the LCD screen, video sensor, audio inputs and outputs and wireless connectivity via the WLAN and the 3G. The user inputs are given to the MID via the touch screen.

The embodiment illustrated in FIG. 6 includes the components required for the MID. For example, the processor 604 and the memory device 606 are essential for the multimedia and the graphics processing. Further, the video input to the MID is via a video sensor and audio input is via a built-in microphone. Furthermore, the MID has both a connected LCD panel and external HD TV interface for video and built-in speaker and headphone for audio output. In addition, network connectivity is via the WLAN or the 3G connectivity used for Internet and media sharing applications. The UI is driven by the touch screen.

The embodiments illustrated in FIGS. 7 and 8 include software required for the MID. Further, the video conferencing STB uses the HAL 728 and the operating system 726 in the generic software platform architecture 700. Furthermore, the web browser framework 720 performs the primary Internet enabled functions. The control and signaling stacks 718 include multiple protocols, such as the RTP module, the HTTP module, the TCP/IP module 718D and the like. The applications, such as the browser application, the e-book application 708C, the play out application, the social network application 704D and the like are used in the MID. Further, applications, such as the video call application 704C and the record application 706B are targeted as differentiated features.

In various embodiments, systems described in FIGS. 6 through 8 provide the generic hardware and software platform for the electronic devices in multimedia, graphics and computing applications. Further, the generic hardware and software platform include the components which enable implementation of various functionalities of the electronic devices. The generic hardware platform is used across a plurality of applications and classes of applications and therefore can be mass manufactured in large volumes at significantly lower cost. Further, the generic hardware platform also significantly reduces the research and development (R&D) investment required compared to separate R&D necessary for developing different hardware platforms for different electronic devices for different applications. Furthermore, the generic hardware platform allows system designers to focus on adding value over and above the given hardware, rather than investing in designing and developing the same.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A generic hardware platform for electronic devices in multimedia, graphics, and computing applications, comprising:
one of a single bus link or a multiple bus link;
one or more of a power module, a processor, a memory device, a security engine, an environmental device, a man machine interface (MMI) device and a medical device;
one or more of an interface to power module, an interface to processor, an interface to memory device, an interface to security engine, an interface to environmental device, an interface to MMI device and an interface to medical device coupled between an associated one of the power module, the processor, the memory device, the security engine, the environmental device, the MMI device and the medical device and the one of the single bus link or the multiple bus link;
one or more of a storage device, a video/image input device, a video/image output device, an audio input device, an audio output device, a location, position, and motion device, a wireless communication channel, a wired communication channel and a timer; and
one or more of an interface to storage device, an interface to video/image input/output (I/O) device, an interface to audio I/O device, an interface to location, position, and motion device, an interface to wireless communication channel, an interface to wired communication channel and an interface to timer coupled between an associated one of the storage device, the video/image input device, the video/image output device, the audio input device, the audio output device, the location, position, and motion device, the wireless communication channel, the wired communication channel and the timer and the one of the single bus link or the multiple bus link.

2. The generic hardware platform of claim 1, wherein the power module comprises at least one of an alternating current (AC) source, a direct current (DC) source, a power over Ethernet (PoE), and a battery, wherein the memory device comprises at least one of a NAND memory, a NOR memory, a synchronous dynamic random access memory (SDRAM), a OneNAND memory and a static random access memory (SRAM), wherein the environmental device comprises at least one of an ambient light sensor, a pressure sensor and a temperature sensor and wherein the security engine comprises a trusted platform module (TPM) defined by a Trusted Computing Group™.

3. The generic hardware platform of claim 1, wherein the processor comprises at least one of a general purpose processor (GPP), a graphics processing unit (GPU), and a video processing unit (VPU).

4. The generic hardware platform of claim 1, wherein the MMI device comprises at least one of an infrared (IR) remote, a Bluetooth® (BT) based universal serial bus (USB) mouse/keyboard, an IR based mouse/keyboard, a touch screen, a keypad, a gesture recognition device and a voice/speech recognition device and wherein the medical device comprises at least one of a personal health record, a glucometer, and a blood pressure monitor.

5. The generic hardware platform of claim 1, wherein the storage device comprises at least one of an USB based flash drive, a hard disk, a multimedia card (MMC), an embedded multimedia card (eMMC™), a secure digital (SD) card, a memory stick and a memory pro, wherein the video/image input device comprises at least one of a camera sensor and an analog/digital camera, wherein the video/image output device comprises at least one of a liquid crystal display (LCD) panel, a standard-definition television (SD TV), a high-definition television (HD TV) and a projector, wherein the audio input device comprises at least one of a microphone, an array microphone, and a line in source and wherein the audio output device comprises at least one of a speaker and an amplifier.

6. The generic hardware platform of claim 1, wherein the location, position and motion device comprises at least one of a gyroscope, a motion sensor, an accelerometer, and a digital compass, wherein the wireless communication channel comprises at least one of a wireless local area network (WLAN), a worldwide interoperability for microwave access (WiMAX™) and a 3^{rd} generation (3G) network, wherein the wired communication channel comprises at least one of a copper communication channel, a fiber communication channel and an USB and wherein the timer comprises at least one of a watchdog timer and a real time clock.

7. The generic hardware platform of claim 1, wherein the interface to power module comprises at least one of an inter-integrated circuit (I2C) and a service provider interface (SPI™), wherein the interface to processor comprises at least one of an advanced microcontroller bus architecture (AMBA™) bus, a peripheral component interconnect express (PCIe), and an advanced graphics port (AGP) and wherein the interface to memory device comprises at least one of a NAND interface, an asynchronous interface, a Motorola™ interface, an Intel™ interface, a synchronous interface and a double data rate (DDR) interface.

8. The generic hardware platform of claim 1, wherein the interface to video/image I/O device comprises at least one of a BT.656, a BT.6620, a high-definition serial digital interface (HD-SDI), a high-definition multimedia interface (HDMI®), a low voltage differential signaling (LVDS), an USB, a separate video (S-video), and a video graphic array (VGA) and wherein the interface to audio I/O device comprises at least one of an integrated interchip sound (I2S) interface, a pulse code modulator (PCM) interface, an audio codec' 97 (AC97) interface, a HDMI®, a HD-SDI, an USB, a peripheral component interconnect (PCI), a PCIe, and a BT.

9. The generic hardware platform of claim 1, wherein the interface to storage device comprises at least one of an USB, a PCI, and a PCIe, wherein the interface to wireless communication channel comprises at least one of an USB, a secure digital input/output (SDIO), a compact flash (CF®), and an universal asynchronous receiver transmitter (UART), wherein the interface to wired communication channel comprises at least one of a media independent interface (MII), a gigabit media independent interface (GMII), a reduced gigabit media independent interface (RGMII), a serial gigabit media independent interface (SGMII), and an USB and wherein the interface to timer comprises at least one of an I2C, a SPI™ and register based interface.

10. The generic hardware platform of claim 1, wherein the interface to location, position and motion device, the interface to MMI device, the interface to medical device, the interface to environmental device, and the interface to security engine comprise at least one of an I2C, a SPI™, an UART, and an USB.

11. A generic software platform for electronic devices in multimedia, graphics, and computing applications, comprising:
a hardware abstraction layer (HAL);
an operating system coupled to the HAL;
middleware coupled to the operating system; and
a plurality of applications coupled to the middleware.

12. The generic software platform of claim 11, wherein the middleware comprises:
a middleware application programming interface (API) layer;
a media engine coupled to the middleware API layer;
control and signaling stacks coupled to the middleware API layer;
a web browser framework coupled to the middleware API layer;
a user interface (UI) framework coupled to the middleware API layer; and
a graphics engine coupled to the middleware API layer.

13. The generic software platform of claim 12, wherein the media engine comprises at least one of a video call module, a recording module, a player module and a streaming module and wherein the control and signaling stacks comprise at least one of a session initiation protocol (SIP) module, a real time streaming protocol (RTSP) module, a digital living network alliance (DLNA) module and a transmission control protocol/Internet protocol (TCP/IP) module.

14. The generic software platform of claim 12, wherein the web browser framework comprises at least one of a rendering engine module, a hypertext markup language (HTML) flash module and a plug-in API module, wherein the UI framework comprises at least one of a widget module, a user input controller module and an event handler module and wherein the graphics engine comprises at least one of a two dimension (2D) engine module, a three dimension (3D) engine module and an open graphics library (GL) API module.

15. The generic software platform of claim 11, wherein the plurality of applications comprises one or more interaction applications, one or more entertainment applications, one or more information applications and one or more user defined applications.

16. The generic software platform of claim 15, wherein the one or more interaction applications comprises at least one of a chat application, a voice call application, a video call application and a social network application, wherein the one or more entertainment applications comprises at least one of a receive application, a share application, a record application and a stream application, wherein the one or more information applications comprises at least one of a ticker application, a really simple syndication (RSS) feed application and an e-book application and wherein the one or more user defined applications comprises at least one of applications to interact or interoperate with other electronic devices.
